(19) United States
(12) Patent Application Publication
(10) Pub. No.: US 2018/0064027 A1
(43) Pub. Date: Mar. 8, 2018

(54) ROTARY CUTTER WITH HAMMER CUTTING ELEMENT

(71) Applicant: Deere & Company, Moline, IL (US)

(72) Inventors: Ivan Alejandro Gonzalez, Monterrey (MX); Bernardo Harvey, Monterrey (MX); Cesar Garcia, Monterrey (MX)

(21) Appl. No.: 15/257,695

(22) Filed: Sep. 6, 2016

(51) Int. Cl. A01D 34/52

(52) U.S. Cl. CPC A01D 34/52; A01D 34/44

(57) ABSTRACT

A rotary cutting implement includes a hammer cutting element. The hammer cutting element includes a shank. The hammer cutting element also includes a cutting head coupled to the shank having a first surface and a second surface. The cutting head includes a projection spaced apart from a blade defined on the first surface. The projection extends beyond a periphery of the shank by a first distance and the projection extends along an axis substantially oblique to a longitudinal axis defined by the hammer cutting element. The hammer cutting element also includes a coating disposed on a portion of at least one of the blade, the first surface and the second surface, and the hammer cutting element has a center of gravity that is offset from the longitudinal axis.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates to implements for use in rotary cutting operations, and to implements with a hammer cutting element.

### BACKGROUND OF THE DISCLOSURE

Various agricultural or other operations may result in residue covering a portion of the area addressed by the operation. In an agricultural setting, for example, residue may include straw, corn stalks, or various other types of plant material, which may be loose or attached to the ground to varying degrees. In order to maintain or clear the area, a rotary cutting implement may be used to cut the residue. Generally, due to the nature of the residue, a cutting element of the rotary cutting implement may wear over time, requiring replacement of the cutting element. Further, in certain instances, the cutting element may require a low speed for rotary cutting implement to ensure that the residue is maintained or cleared by the rotary cutting implement, which reduces productivity of the rotary cutting implement.

### SUMMARY OF THE DISCLOSURE

The disclosure provides an implement with a hammer cutting element, which has improved resistance to wear and an improved impact force that enables the rotary cutting implement to move at a higher speed to maintain or clear the residue, thereby improving productivity.

In one aspect the disclosure provides a hammer cutting element for a rotary cutting implement. The hammer cutting element includes a shank. The hammer cutting element also includes a cutting head coupled to the shank having a first surface and a second surface. The cutting head includes a projection spaced apart from a blade defined on the first surface. The projection extends beyond a periphery of the shank by a first distance and the projection extends along an axis substantially oblique to a longitudinal axis defined by the hammer cutting element. The hammer cutting element also includes a coating disposed on a portion of at least one of the blade, the first surface and the second surface, and the hammer cutting element has a center of gravity that is offset from the longitudinal axis.

In another aspect the disclosure provides a hammer cutting element for a rotary cutting implement. The hammer cutting element includes a shank having a first body section offset from a second body section. The first body section extends along a first axis. The hammer cutting element also includes a cutting head coupled to the second body section. The cutting head includes a projection spaced apart from a blade on a first surface. The projection extends along an axis substantially oblique to the first axis and extends beyond a periphery of the shank by a first distance. The blade extends beyond a periphery of the shank by a second distance, and the first distance is greater than the second distance. The blade has a cutting surface area that is different than a surface area of the projection.

In yet another aspect the disclosure provides a rotary cutting implement. The rotary cutting implement includes a cutting blade assembly. The cutting blade assembly includes a pan and at least one hammer cutting element coupled to the pan. The hammer cutting element extends along a longitudinal axis and has a center of gravity that is offset from the longitudinal axis. The hammer cutting element includes a shank having a first body section that extends along a first axis and a second body section that extends along a second axis. The second axis is substantially transverse to the first axis. The hammer cutting element includes a cutting head coupled to the second body section. The cutting head includes a projection spaced apart from a blade on a first surface. The projection extends along an axis substantially oblique to the first axis and extends beyond a periphery of the shank by a first distance. The blade extends beyond a periphery of the shank by a second distance, and the first distance is greater than the second distance. The hammer cutting element also includes a coating disposed on a portion of the cutting head.

The details of one or more embodiments are set forth in the accompanying drawings and the description below. Other features and advantages will become apparent from the description, the drawings, and the claims.

### BRIEF DESCRIPTION OF THE DRAWINGS

FIG. 1 is a perspective view of an example work machine in the form of a tractor towing a rotary cutting implement with a plurality of hammer cutting elements;

FIG. 2 is a rear view of the rotary cutting implement having a plurality of cutting blade assemblies that each include the plurality of hammer cutting elements of FIG. 1;

FIG. 3 is a top perspective view of one of the plurality of cutting blade assemblies, which includes the plurality of hammer cutting elements;

FIG. 4 is a top perspective view of one of the plurality of hammer cutting elements;

FIG. 5 is a first side view of the one of the plurality of hammer cutting elements;

FIG. 6 is a second side view of the one of the plurality of hammer cutting elements;

FIG. 7 is a front end view of the one of the plurality of hammer cutting elements;

FIG. 8 is a top plan view of the one of the plurality of hammer cutting elements; and

FIG. 9 is a bottom plan view of the one of the plurality of hammer cutting elements;

FIG. 10 is a bottom plan view of the one of the plurality of hammer cutting elements, which includes an alternative application for a coating;

FIG. 11 is a bottom plan view of the one of the plurality of hammer cutting elements, which includes another alternative application for a coating;

FIG. 12 is a first side view of the one of the plurality of hammer cutting elements, which includes an alternative application for a coating; and

FIG. 13 is a bottom plan view of the one of the plurality of hammer cutting elements of FIG. 12.

Like reference symbols in the various drawings indicate like elements.

### DETAILED DESCRIPTION

The following describes one or more example embodiments of the disclosed system, as shown in the accompanying figures of the drawings described briefly above. Various modifications to the example embodiments may be contemplated by one of skill in the art.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

As noted above, various operations may result in residue on a field. Various agricultural machines (e.g., rotary cutting implements, primary and secondary tillage implements, and so on) have very wide platforms for mounting various tools for working crop fields. To allow for transport on roadways, the implements may be formed in sections, one or more of which are able to fold inward alongside or above a main fame of the implement, which has a controlled (e.g., regulated) width or lateral dimension. The sections may be hinged together and pivot with respect to one another between an operational position, in which the “wing” frame sections are generally parallel with the main frame section, and a transport position, in which the wing sections are folded up and/or over the main frame section. An implement may have as few as one main frame section and one wing section, or it may have several wing sections, such as multiple (e.g., inner and outer) wing sections on each side of the main frame section.

In the example of a rotary cutting implement, the rotary cutting implement can be towed along a field, by a work vehicle, for example, to cut residue on the field. Typically, rotary cutting implements have a cutting element, which moves to cut the residue on the field. Due to various factors, these cutting elements wear over time, which reduces the productivity of the rotary cutting element and increases operating costs due to repairs and replacement of the cutting element. Moreover, due to an impact force associated with a conventional cutting element, the cutting element generally requires a low speed for the movement of the rotary cutting implement across the field to ensure that the residue is cut properly, which reduces productivity of the rotary cutting implement. The disclosed system, however, improves productivity of the rotary cutting implement by reducing operating costs and improving an operational speed for the rotary cutting implement.

In this regard, the cutting blade assembly of the disclosed rotary cutting implement includes one or more hammer cutting elements having a coating applied to at least a portion of a cutting head, which results in about 30% improved life or wear over a conventional cutting element. The improved life of the hammer cutting elements reduces replacement and repair costs. Moreover, the disclosed hammer cutting element includes a hammer or a projection that extends beyond a perimeter or periphery of a shank of the hammer cutting element to increase impact force. The disclosed hammer cutting element has an impact force that is about 25% to about 35% greater than a conventional cutting element. This increase in impact force enables the rotary cutting implement to be towed by the work vehicle across the field at a greater speed, such as about 7 kilometers per hour (kph), which increases the productivity of the rotary cutting implement. In addition, the disclosed hammer cutting element has a longer cutting edge, which also allows for the rotary cutting implement to be towed by the work vehicle across the field at the greater speed. Further, the disclosed hammer cutting element enables the rotary cutting implement to cut thicker material and to operate with less power spikes, which increases a cut capacity of the disclosed rotary cutting implement as compared to a rotary cutting implement with a conventional cutting element.

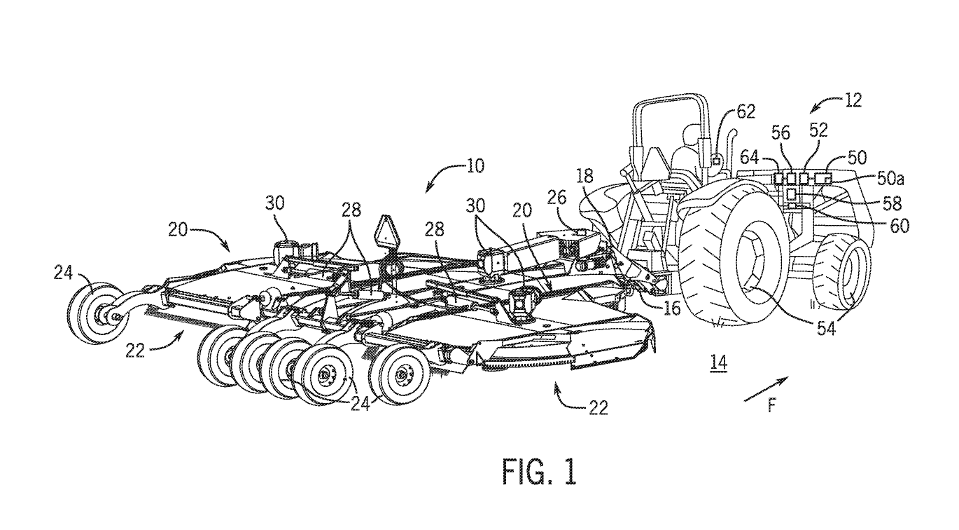

As noted above, the system described herein may be employed with respect to a variety of implements, including various agricultural or other work implements. In certain embodiments, the described system may be implemented with respect to a rotary cutting implement. It will be understood, however, that the system disclosed herein may be used with various other work implements, such as a residential riding mower. Referring to FIG. 1, in some embodiments, the disclosed system is used with a rotary cutting implement 10, which is towed by a work vehicle 12, such as a tractor. It will be understood that the configuration of the rotary cutting implement 10 coupled to the work vehicle 12 is presented as an example only. Moreover, the depicted embodiment illustrates the work vehicle 12 as a tractor. It should be understood that the work vehicle 12 may comprise any suitable vehicle for towing the rotary cutting implement 10, and thus, the use of the tractor is merely an example.

In the embodiment depicted, rotary cutting implement 10 includes a coupling mechanism 16 for coupling the rotary cutting implement 10 to the work vehicle 12. This allows the rotary cutting implement 10 to be towed across a field 14 in a forward direction F in order to execute a cutting operation. It will be understood that other embodiments may include self-driven implements that may execute various operations without being towed by a separate work vehicle.

The rotary cutting implement 10 includes a main frame 18, which is coupled to the coupling mechanism 16 and generally extends in an aft direction away from the coupling mechanism 16. In this example, the rotary cutting implement 10 is a multi-section implement with the main frame 18 coupled at each side to folding wing sections 20. Each of the main frame 18 and the folding wing sections 20 include a cutting chamber 22. It will be understood that while the rotary cutting implement 10 is described and illustrated herein as a multi-section implement, the rotary cutting implement 10 may include a single frame section with a single cutting chamber 22, if desired. In certain embodiments, a plurality of wheel assemblies 24 may also be coupled to the main frame 18 and/or the folding wing sections 20, in order to support the main frame 18 and/or the folding wing sections 20 above the field 14. The folding wing sections 20 can be movably coupled on either side of the main frame 18 via one or more hinges.

The rotary cutting implement 10 includes (or may be in communication with) one or more controllers, which may include various electrical, computerized, electro-hydraulic, or other controllers. In certain embodiments, for example, an electrohydraulic controller 26 is mounted to the coupling mechanism 16. The controller 26 may include various processors (not shown) coupled with various memory architectures (not shown), as well as one or more electrohydraulic valves (not shown) to control the flow of hydraulic control signals to various devices included on the rotary cutting implement 10. In certain embodiments, the controller 26 may be in communication with a CAN bus associated with the rotary cutting implement 10 or the work vehicle 12.

In certain embodiments, one or more hydraulic cylinders 28 (or other lift devices) may be coupled to the folding wing sections 20 and the wheel assemblies 24. The hydraulic cylinders 28 may be in hydraulic (or other) communication with the controller 26, such that the controller 26 outputs one or more control signals to the hydraulic cylinders 28 to raise or lower the folding wing sections 20 relative to the main frame 18 to fold or unfold the rotary cutting implement 10. The hydraulic cylinder 28 associated with the wheel assemblies 24 is in communication with the controller 26 to receive one or more control signals in order to move the main frame 18 to various orientations relative to the field 14. It will be understood that other configurations may also be possible. For example, in certain embodiments, the hydraulic cylinders 28 (or another lift device) may be coupled directly to the main frame 18 (or associated support components) rather than the wheel assemblies 24, in order to directly move the main frame 18 relative to the field 14.

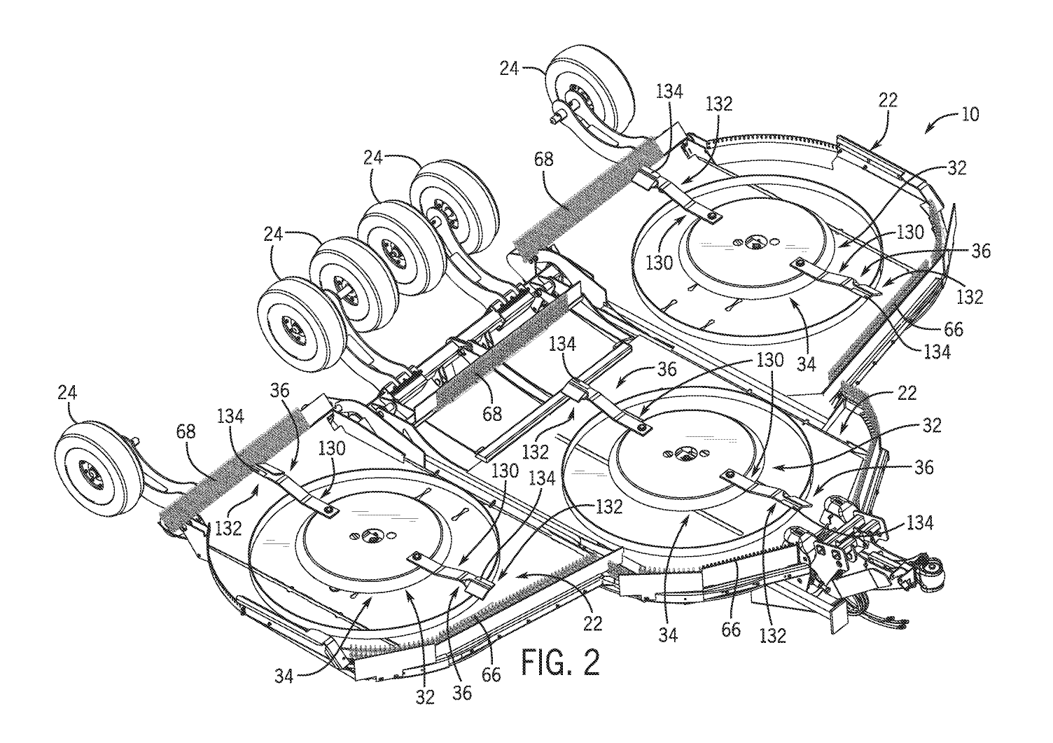

Various other control devices and systems may be included on or otherwise associated with the rotary cutting implement 10. For example, with reference to FIG. 1, one or more hydraulic motors 30 can be associated with each one of the cutting chambers 22 to drive a respective cutting blade assembly 32 (FIG. 2). Each of the hydraulic motors 30 are in communication with the controller 26 to receive one or more control signals to drive the hydraulic motors 30, and thus, the cutting blade assembly 32. In one example, as shown in FIG. 2 and as discussed in greater detail below, the cutting blade assembly 32 includes a pan 34 coupled to two hammer cutting elements 36. The hammer cutting elements 36 have improved life over conventional cutting elements, enable the movement of the rotary cutting implement 10 at a faster speed across the field F (FIG. 1) and have a higher cutting capacity as compared to conventional cutting elements, which improves productivity. In one example, with reference to FIG. 1, the hammer cutting elements 36 enable the rotary cutting implement 10 to move across the field F at a speed of about 7.0 kilometers per hour (kph), while cutting and maintaining the residue on the field F.

The work vehicle 12 includes a source of propulsion, such as an engine 50. The engine 50 supplies power to a transmission 52. The transmission 52 transfers the power from the engine 50 to a suitable driveline coupled to one or more driven wheels 54 (and tires) of the work vehicle 12 to enable the work vehicle 12 to move. In one example, the engine 50 is an internal combustion engine, such as a diesel engine, that is controlled by an engine control module 50a. It should be noted that the use of an internal combustion engine is merely exemplary, as the propulsion device can be a fuel cell, electric motor, a hybrid-electric motor, etc.

The work vehicle 12 also includes one or more pumps 56, which may be driven by the engine 50 of the work vehicle 12. Flow from the pumps 56 may be routed through various control valves 58 and various conduits (e.g., flexible hoses) to the controller 26 in order to drive the hydraulic cylinders 28 and hydraulic motors 30. Flow from the pumps 56 may also power various other components of the work vehicle 12. The flow from the pumps 56 may be controlled in various ways (e.g., through control of the various control valves 58 and/or the controller 26), in order to cause movement of the hydraulic cylinders 28 and the hydraulic motors 30, and thus, the folding wing sections 20 and cutting blade assembly 32 of the rotary cutting implement 10. In this way, for example, a movement of a portion of the rotary cutting implement 10 may be implemented by various control signals to the pumps 56, control valves 58, controller 26 and so on.

Generally, a controller 60 (or multiple controllers) may be provided, for control of various aspects of the operation of the work vehicle 12, in general. The controller 60 (or others) may be configured as a computing device with associated processor devices and memory architectures, as a hard-wired computing circuit (or circuits), as a programmable circuit, as a hydraulic, electrical or electro-hydraulic controller, or otherwise. As such, the controller 60 may be configured to execute various computational and control functionality with respect to the work vehicle 12 (or other machinery). In some embodiments, the controller 60 may be configured to receive input signals in various formats (e.g., as hydraulic signals, voltage signals, current signals, and so on), and to output command signals in various formats (e.g., as hydraulic signals, voltage signals, current signals, mechanical movements, and so on). In some embodiments, the controller 60 (or a portion thereof) may be configured as an assembly of hydraulic components (e.g., valves, flow lines, pistons and cylinders, and so on), such that control of various devices (e.g., pumps or motors) may be effected with, and based upon, hydraulic, mechanical, or other signals and movements.

The controller 60 may be in electronic, hydraulic, mechanical, or other communication with various other systems or devices of the work vehicle 12 (or other machinery, such as the rotary cutting implement 10). For example, the controller 60 may be in electronic or hydraulic communication with various actuators, sensors, and other devices within (or outside of) the work vehicle 12, including various devices associated with the pumps 56, control valves 58, controller 26, and so on. The controller 60 may communicate with other systems or devices (including other controllers, such as the controller 26) in various known ways, including via a CAN bus (not shown) of the work vehicle 12, via wireless or hydraulic communication means, or otherwise.

In some embodiments, the controller 60 may be configured to receive input commands and to interface with an operator via the human-machine interface 62, which may be disposed on a portion of the work vehicle 12 for easy access by the operator. The human-machine interface 62 may be configured in a variety of ways. In some embodiments, the human-machine interface 62 may include one or more joysticks, various switches or levers, one or more buttons, a touchscreen interface that may be overlaid on a display, a keyboard, a speaker, a microphone associated with a speech recognition system, or various other human-machine interface devices.

Various sensors may also be provided to observe various conditions associated with the work vehicle 12 and/or the rotary cutting implement 10. In some embodiments, various sensors 64 (e.g., pressure, flow or other sensors) may be disposed near the pumps 56 and control valves 58, or elsewhere on the work vehicle 12. For example, sensors 64 may comprise one or more pressure sensors that observe a pressure within the hydraulic circuit, such as a pressure associated with at least one of the one or more hydraulic cylinders 28 and/or hydraulic motors 30. The sensors 64 may also observe a pressure associated with the pumps 56.

The various components noted above (or others) may be utilized to control the rotary cutting implement 10 via control of the movement of the one or more hydraulic cylinders 28 and hydraulic motors 30, and thus, the cutting blade assembly 32. Accordingly, these components may be viewed as forming part of the rotary cutter control system for the work vehicle 12 and/or rotary cutting implement 10.

With reference to FIG. 2, the rotary cutting implement 10 is shown in more detail. As discussed, the rotary cutting implement 10 includes three cutting chambers 22, each coupled to a respective one of the main frame 18 and the folding wing sections 20. The rotary cutting implement 10 also includes one or more forward cutting guards 66 and one or more rear cutting guards 68. Each of the three cutting chambers 22 includes a respective cutting blade assembly 32. As each of the cutting blade assemblies 32 are substantially similar or the same, a single one of the cutting blade assemblies 32 will be discussed in detail herein and the same reference numerals will be used to denote the same or similar components.

In one example, the cutting blade assembly 32 includes the pan 34 and the two hammer cutting elements 36. In this example, the pan 34 is generally annular, and has a body 100 and a flange 102. The body 100 has a first end 104 and a diametrically opposed second end 106, and includes a mounting bracket 108 that extends along a diameter of the body 100. Generally, the mounting bracket 108 comprises a blade bar or stump jumper for the pan 34. The mounting bracket 108 has a first end 110 coupled at the first end 104 of the body 100, and a second end 112 coupled to the second end 106 of the body 100. A midsection 114 extends between the first end 110 and the second end 112. In one example, the midsection 114 is raised relative to a surface of the first end 110 and the second end 112 to facilitate in coupling the cutting blade assembly 32 to the cutting chamber 22. Each of the first end 110, the second end 112 and the midsection 114 define a respective bore 110a, 112a, 114a. The bore 110a and the bore 112a each receive a respective mechanical fastener, such as a bolt, to couple a respective one of the hammer cutting elements 36 to the body 100 of the pan 34. The bore 114a is defined through the midsection 114 so as to be coaxial with a bore 116 defined through the body 100. Generally, the bore 116 is defined along a central axis C of the body 100, such that the bore 116 is coaxial with the central axis C. The bore 114a receives a portion of the hydraulic motor 30 to couple the hydraulic motor 30 to the pan 34. In one example, the bore 114a receives an output shaft or spindle of the hydraulic motor 30, which is coupled to the bore 114a, and thus, the pan 34, via a mechanical fastener, such as a nut. Generally, the bore 116 provides clearance for the removal of the cutting blade assembly 32 from the hydraulic motor 30, and thus, cutting chamber 22, as illustrated in FIG. 2. In this regard, the bore 116 provides access to the mechanical fastener that couples the hydraulic motor 30 to the pan 34. The output shaft of the hydraulic motor 30 is fixedly coupled to the body 100 of the pan 34 via the bore 116 such that the rotation of the output shaft by the hydraulic motor 30 rotates the pan 34.

The flange 102 extends about a perimeter or circumference of the body 100. The flange 102 can be angled relative to a surface of the body 100, and can protect the portion of the hydraulic motor 30 coupled to the pan 34 from debris as the rotary cutting implement 10 moves across the field F. In certain embodiments, one or more stiffening ribs 118 are coupled to a surface of the body 100 to extend between diametrically opposed ends of the flange 102 over the mounting bracket 108. In this example, the pan 34 includes two stiffening ribs 118, which are spaced apart from each other so as to be on opposite sides of the midsection 114. The stiffening ribs 118 generally extend along an axis, which is substantially transverse, and in this example, substantially parallel to a longitudinal axis L of the cutting blade assembly 32. The pan 34, including the body 100, flange 102, mounting bracket 108 and the stiffening ribs 118, are each generally composed of a metal or metal alloy, and are stamped, cast or machined and assembled to define the pan 34. In certain embodiments, the flange 102, mounting bracket 108 and the stiffening ribs 118 are welded to the body 100, but one or more mechanical fasteners can be employed. Further, one or more of the body 100, flange 102, mounting bracket 108 and the stiffening ribs 118 can be integrally formed, if desired.

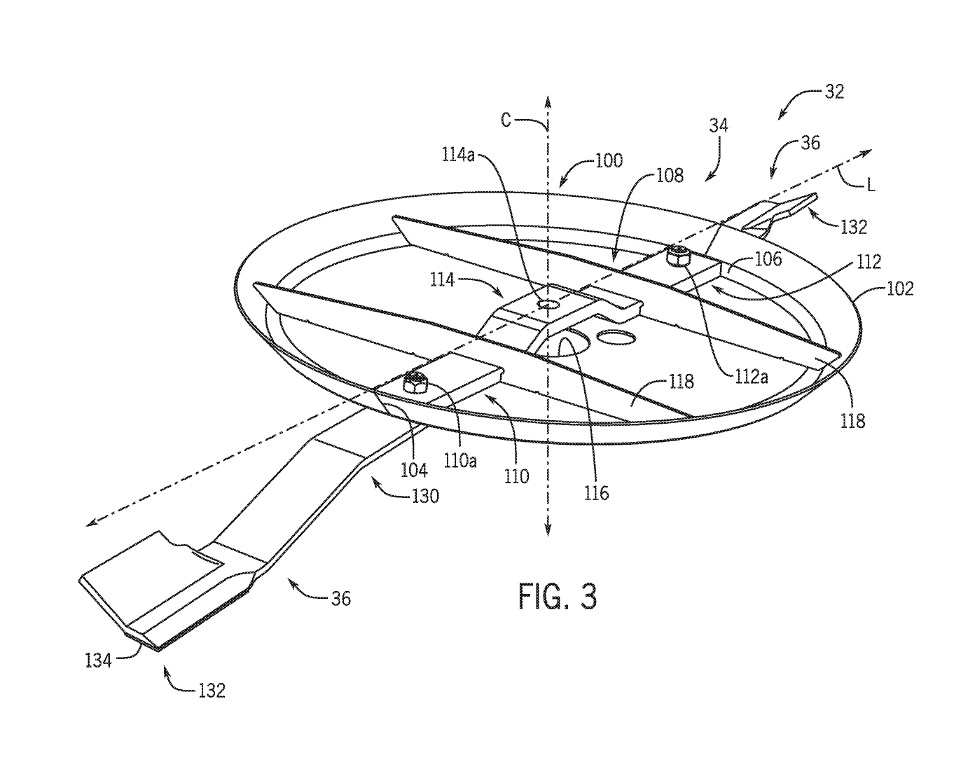

With continued reference to FIG. 3, each of the hammer cutting elements 36 are coupled to the first end 110 and the second end 112 of the mounting bracket 108, respectively. Each of the hammer cutting elements 36 are coupled to the mounting bracket 108 so as to extend outwardly from the pan 34 along the longitudinal axis L. It should be noted that while two hammer cutting elements 36 are described and illustrated herein, the pan 34 can include additional mounting points for additional hammer cutting elements 36 as desired. Generally, as each of the hammer cutting elements 36 are substantially similar or the same, a single one of the hammer cutting elements 36 will be described in detail herein, with the same reference numerals used to denote the same or similar features. The hammer cutting element 36 includes a shank 130, a cutting head 132 and a coating 134.

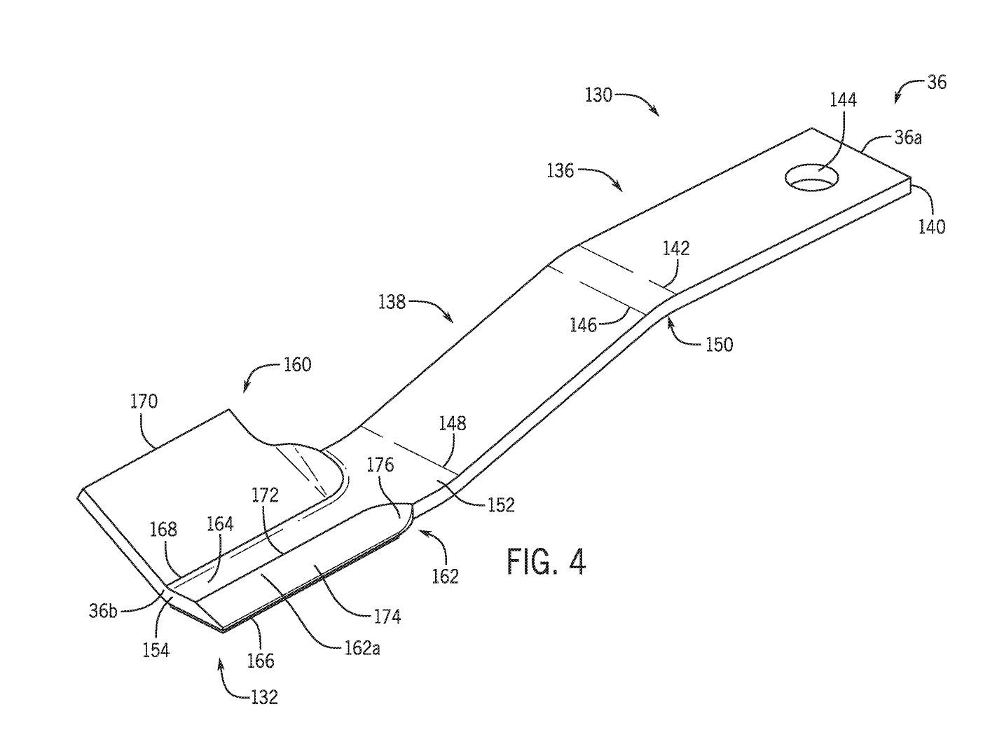

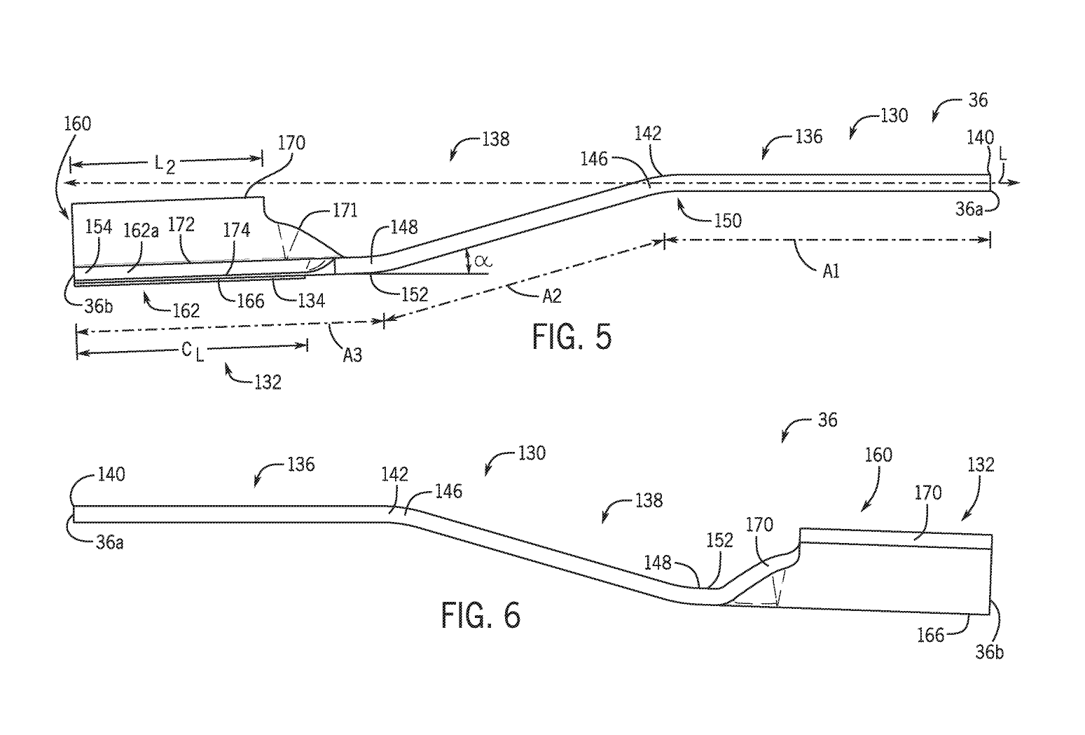

The shank 130 couples the hammer cutting element 36 to the mounting bracket 108 of the pan 34. With reference to FIG. 4, the shank 130 includes a first body section 136 and a second body section 138. The first body section 136 comprises a proximal end 36a of the hammer cutting element 36. With additional reference to FIG. 5, the first body section 136 extends along a first axis A1, which is substantially parallel to the longitudinal axis L. In this example, the longitudinal axis L defines a centerline for the hammer cutting element 36. The first body section 136 includes a first end 140 and a second end 142. The first end 140 defines the proximal end 36a of the hammer cutting element 36, and the second end 142 is coupled to the second body section 138. With reference to FIG. 4, the first body section 136 defines a bore 144, which receives the mechanical fastener to couple the shank 130 to the pan 34 (FIG. 3). The bore 144 is generally defined adjacent to the first end 140 and defines a pivot axis for the hammer cutting element 36.

The second body section 138 includes a third end 146 and a fourth end 148. The third end 146 is coupled to the second end 142 of the first body section 136. The second body section 138 is generally offset from the first body section 136. In one example, the third end 146 is coupled to the second end 142 via a radius 150. With reference to FIG. 5, in this example, the radius 150 comprises about 75 degrees to about 125 degrees. Generally, the second body section 138 is coupled to the first body section 136 so as to extend along a second axis A2, which is substantially transverse to the first axis A1 and is substantially transverse to the longitudinal axis L. By extending along the second axis A2, the second body section 138 provides clearance for the cutting head 132 to rotate about the pan 34 and within the cutting chamber 22. The fourth end 148 is coupled to the cutting head 132.

The cutting head 132 includes a fifth end 152 and a sixth end 154. The sixth end 154 comprises a distal end 36b of the hammer cutting element 36. The fifth end 152 is coupled to the fourth end 148 of the second body section 138. In one example, the fifth end 152 is coupled to the second body section 138 at an angle α. In this example, the angle α is about 1.0 degrees to about 3.0 degrees. The cutting head 132 extends along a third axis A3, which is substantially transverse to the second axis A2; substantially transverse to the longitudinal axis L; and is substantially transverse to the first axis A1.

With reference to FIG. 4, the cutting head 132 includes a hammer or projection 160 and a blade 162. Generally, the projection 160 and the blade 162 are defined on the cutting head 132 from the sixth end 154 to be adjacent to the fifth end 152. The projection 160 extends upwardly from a first surface 164 of the cutting head 132 to increase an impact force of the cutting head 132. In one example, the projection 160 increases a mass of the cutting head 132, and thus, the hammer cutting element 36 by about 7% over a conventional cutting element, which increase an impact force of the cutting head 132 by about 30% over a conventional cutting element.

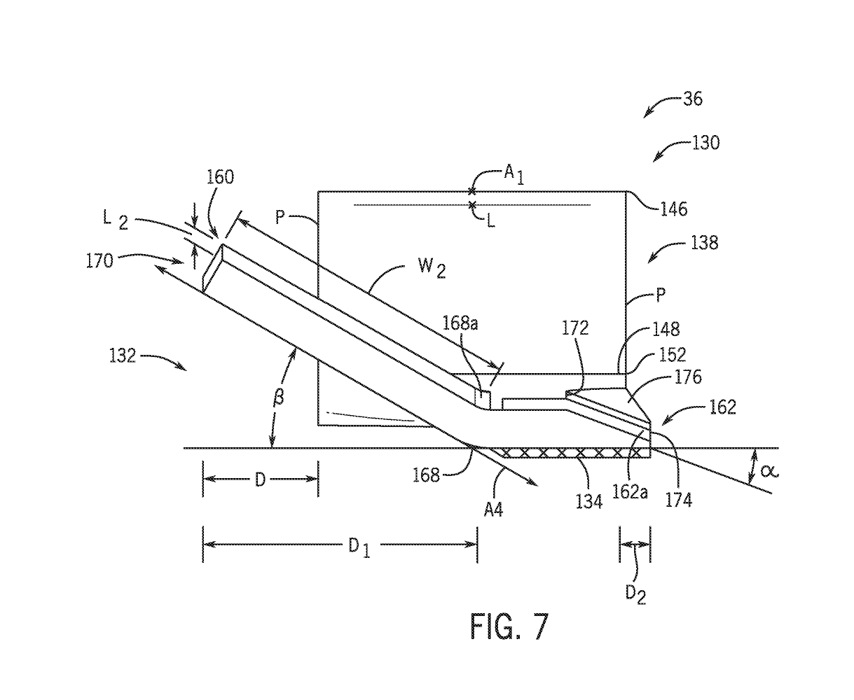

With reference to FIG. 7, the projection 160 extends at an angle β relative to a second surface 166 of the cutting head 132. The second surface 166 of the cutting head 132 is substantially opposite the first surface 164. In one example, the angle β is about 20 degrees to about 40 degrees, and in one example, the angle β is about 30 degrees. The angle β of the projection 160 increases an amount of airflow or suction created by the rotation of the hammer cutting element 36. In this example, the angle of about 30 degrees increases suction by about 20% compared to a conventional cutting element.

The projection 160 extends from a root 168 to a tip 170. The root 168 is coupled to or defined from the first surface 164 at a radius 168a. In one example, the radius 168a is about 5 degrees to about 15 degrees. The tip 170 extends away from the cutting head 132 so as to extend beyond a periphery P defined by the shank 130. In one example, the tip 170 of the projection 160 extends beyond the periphery P of the shank 130 by a distance D. In this example, the distance D is about 20 millimeters (mm) to about 50 millimeters (mm). Generally, the projection 160 extends along a fourth axis A4, which is substantially oblique to the first axis A3, and thus, substantially oblique to the longitudinal axis L. In this example, the projection 160 extends for a total distance D1 relative to the first surface 164 and the second surface 166 of the cutting head 132. In one example, the total distance D1 is about 60 millimeters (mm) to about 110 millimeters (mm). It should be noted that the total distance D1 of the projection 160 can be up to about 150 millimeters (mm).

The projection 160 has a width W2, which can be range from about 30 millimeters (mm) to about 50 millimeters (mm). In one example, the width W2 is about 47 millimeters (mm). With reference to FIG. 5, the projection 160 can have a length L2, which in this example, extends substantially over a portion of the cutting head 132. In this example, the length L2 is about 100 millimeters (mm) to about 180 millimeters (mm), and in one example, the length L2 is about 152 millimeters (mm). Thus, in one example, the surface area of the projection 160 is about 7144 millimeters squared (mm²).

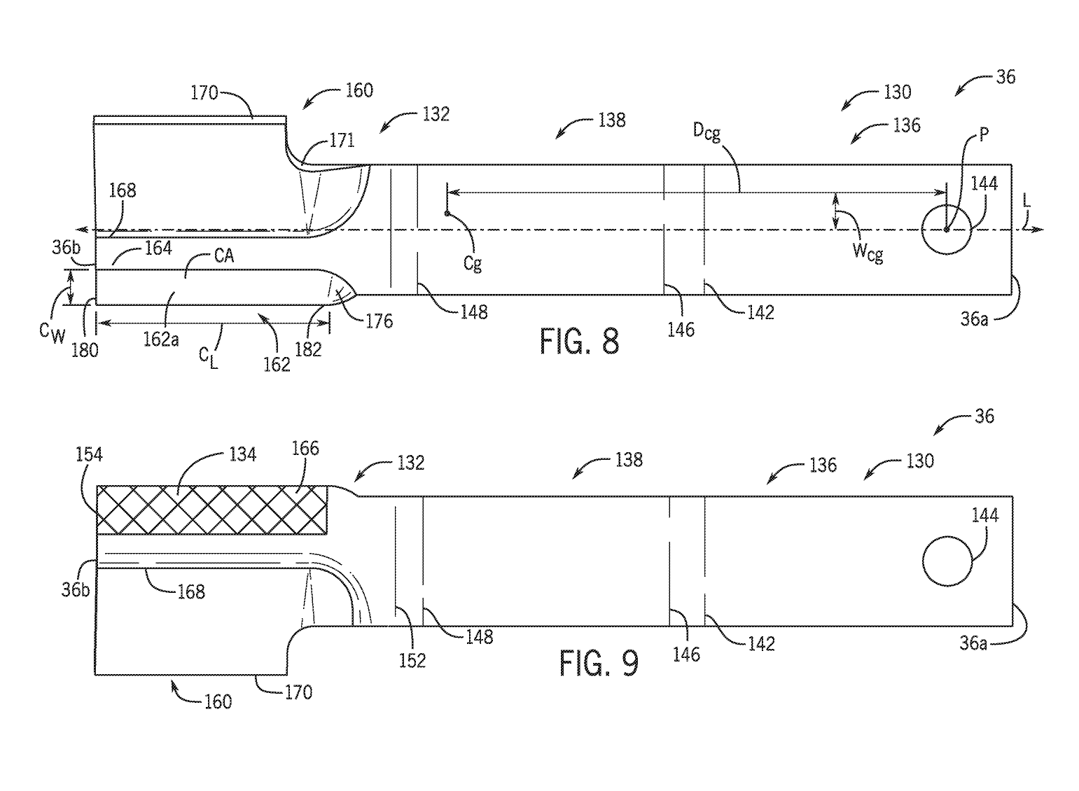

With reference to FIG. 8, the projection 160 shifts a center of gravity Cg of the hammer cutting element 36 off of the centerline or longitudinal axis L. In one example, the center of gravity Cg is shifted off of the centerline or longitudinal axis L by a width Wcg. In one example, the width Wcg is about 4 millimeters (mm) to about 8 millimeters (mm). The projection 160 also displaces the center of gravity Cg a distance Dcg from a central axis P defined by the bore 144. In this example, the distance Dcg is about 325 millimeters (mm) to about 345 millimeters (mm) from the central axis P. Thus, the projection 160 also shifts the center of gravity Cg of the hammer cutting element 36 towards the cutting head 132 and shifts the center of gravity Cg radially offset from the centerline or longitudinal axis L of the hammer cutting element 36.

In certain instances, with reference to FIG. 5, a curved surface 171 can interconnect the tip 170 of the projection 160 with the first surface 164. The curved surface 171 can be defined during the formation of the projection 160, and in one example, can be defined during the stamping of the cutting head 132 to define the projection 160. Thus, the curved surface 171 illustrated herein is merely exemplary, as the projection 160 may be formed using various techniques which do not result in the curved surface 171.

The blade 162 is defined on the cutting head 132 substantially opposite the projection 160. The blade 162 has a cutting length CL defined from the sixth end 154 to near the fifth end 152. In one example, the cutting length CL is about 110 millimeters (mm) to about 250 millimeters (mm), and for example, the cutting length CL can be about 180 millimeters (mm). Generally, the cutting length CL is different than the length L2 of the projection 160, and in one example, the cutting length CL is greater than the length L2 of the projection 160. The blade 162 tapers along the first surface 164 from a first blade end 172 to a second blade end 174. Stated another way, a surface 162a of the blade 162 is sloped at an angle γ relative to the second surface 166 of the cutting head 132. In one example, the angle γ is about 15 degrees to about 25 degrees. The second blade end 174 is generally adjacent to the second surface 166 of the cutting head 132, such that the surface 162a of the blade 162 transitions or slopes from the first surface 164 to the second surface 166. In certain instances, the blade 162 can have a curved endwall 176, which transitions the surface 162a of the blade 162 to the first surface 164 of the cutting head 132. The curved endwall 176 is generally defined during the formation of the surface 162a of the blade 162. In one example, the blade 162 extends beyond the periphery P of the shank 130 by a distance D2. In this example, the distance D2 can be about 5 millimeters (mm) to about 15 millimeters (mm). Thus, the distance D2 is generally less than the distance D that the projection 160 extends beyond the periphery P of the shank 130. With reference to FIG. 8, the blade 162 has a cutting width CW of about 20 millimeters (mm) to about 40 millimeters (mm), and in one example, the cutting width CW is about 28 millimeters (mm). Thus, in one example, the blade 162 has a cutting area of about 5040 millimeters squared (mm²). The cutting area of the blade 162 is different than the surface area of the projection 160, and in this example, the cutting area of the blade 162 is less than the surface area of the projection 160.

The coating 134 is applied to one or more surfaces of the cutting head 132 to improve the life of the cutting head 132. In certain examples, the coating 134 improves the life of the cutting head 132 by about 30% as compared to an uncoated cutting element. Although the coating 134 is illustrated herein as a layer upon the respective surface of the cutting head 132 for clarity, the coating 134 need not protrude from the respective surface of the cutting head 132 as shown. In one example, with reference to FIG. 9, the coating 134 is applied to at least a portion of the second surface 166 of the cutting head 132 (FIG. 9). In FIGS. 9-13, the coating 134 is illustrated with cross-hatching to visually distinguish the coated areas from the non-coated areas. It should be noted that the coating 134 can cover more or less of these areas, and that the application of the coating 134 illustrated in FIGS. 9-13 is merely an example.

With reference to FIG. 9, the coating 134 covers substantially an entirety of the second surface 166. In this example, the coating 134 covers about 70% to about 95% of the second surface 166. Generally, the coating 134 on the second surface 166 extends from the sixth end 154 to an area adjacent to the fifth end 152. In one example, the coating 134 is applied over about 180 millimeters (mm) to about 35 millimeters (mm) of rectangular portion of the second surface 166. The coating 134 is applied to the second surface 166 so as to be substantially opposite the blade 162 so that the coating 134 maintains a sharp cutting surface as the surface of the blade 162 is worn by the cutting operation.

In this example, the coating 134 comprises a tungsten carbide coating, which is applied by thermally spraying the coating 134 onto the portion of the second surface 166 of the cutting head 132 (FIG. 9). For example, the coating 134 is applied by a high velocity oxygen fuel spraying (HVOF) process; however the coating 134 may be applied using any technique. It should be noted that while tungsten carbide is applied in this example for the coating 134, any suitable wear resistant coating may be applied. Generally, the coating 134 is applied prior to heat treating the hammer cutting element 36. In this example, the coating 134 is applied to the second surface 166 of the blade 162 so as to be about 1 millimeter (mm) to about 2 millimeters (mm) thick.

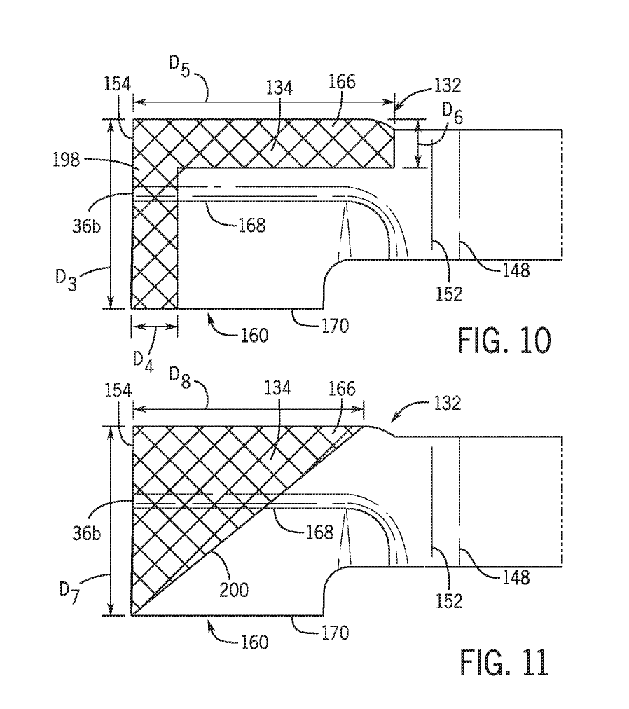

It should be noted that while the coating 134 is described and illustrated herein as being applied to the portion of the second surface 166 of the cutting head 132 (FIG. 9), the present disclosure is not so limited. In this regard, with reference to FIG. 10, the coating 134 is shown applied in a substantially L-shaped area 198 to the second surface 166 of the cutting head 132 and a portion of the projection 160. In this example, the coating 134 is applied over a distance D3, a distance D4, a distance D5 and a distance D6. In one example, distance D3 ranges from about 100 millimeters (mm) to about 120 millimeters (mm), distance D4 is substantially equal to D6 and ranges from about 30 millimeters (mm) to about 40 millimeters (mm) and distance D5 ranges from about 140 millimeters (mm) to about 160 millimeters (mm). Generally, in this example, the coating 134 is applied to the distalmost end of the cutting head 132 along the second surface 166 and the portion of the projection 160, and is also applied so as to be substantially opposite the blade 162.

As a further alternative, with reference to FIG. 11, the coating 134 is shown applied over a triangular portion 200 that includes both a portion of the second surface 166 of the cutting head 132 and a portion of the projection 160. In this example, the coating 134 is applied to extend a distance D7 and a distance D8. In one example, the distance D7 ranges from about 100 millimeters (mm) to about 120 millimeters (mm) and the distance D8 ranges from about 130 millimeters (mm) to about 150 millimeters (mm).

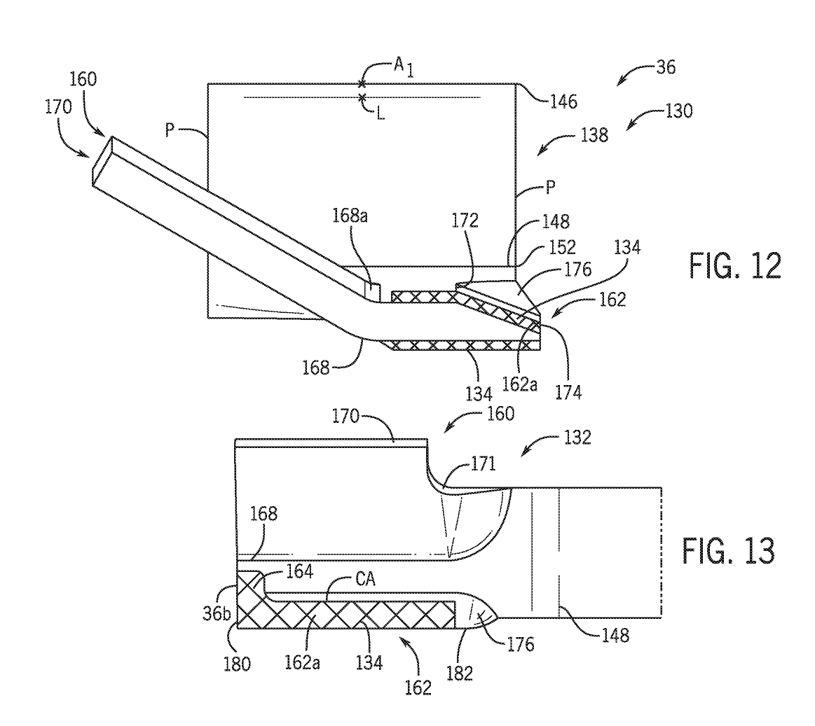

As another alternative, with reference to FIGS. 12 and 13, the coating 134 is applied to the surface 162a of the blade 162, the portion of the first surface 164 (FIG. 13) 3:3 and the portion of the second surface 166 of the cutting head 132 (FIG. 12). Thus, in this example, the coating 134 can be applied to the second surface 166 in a rectangular area, as discussed with regard to FIG. 9, but is also applied to the surface 162a so as to extend along the blade 162 and the portion of the first surface 164. The application of the coating over opposite sides of the blade 162 further improves the wear resistance of the blade 162. As shown in FIG. 13, the coating 134 covers a portion of the first surface 164 adjacent to the distal end 36b of the hammer cutting element 36. Generally, the projection 160 does not include the coating 134 and is devoid of the coating 134. The coating 134 also covers a substantial portion of the surface 162a of the blade 162. In this example, the coating 134 covers the surface 162a from a first end 180 of the surface 162a to an area adjacent to a second end 182 of the surface 162a. In this example, the coating 134 does not cover the curved endwall 176. The coating 134 extends along the surface 162a from the first end 180 to near the second end 182 such that a contact area CA of the blade 162 is protected by the coating 134. In certain examples, the contact area CA can be defined as about 30% to about 80% of the blade 162.

In one example, with reference back to FIGS. 4-9, the hammer cutting element 36 is formed from 5160 steel; however, the hammer cutting element 36 can be composed of any suitable metal or metal alloy. In this example, the hammer cutting element 36 is stamped from a sheet of 5160 steel, and the portion of the second surface 166 of the cutting head 132 (FIG. 9) is coated with the coating 134 by thermal spraying the coating 134, in this example, tungsten carbide, onto the portion of the second surface 166 of the cutting head 132 (FIG. 9). With the coating 134 disposed on or applied to the portion of the second surface 166 of the cutting head 132 (FIG. 9, the hammer cutting element 36 is heat treated. In one example, the heat treatment for the hammer cutting element 36 comprises an austempering heat treatment process. Once the hammer cutting element 36 has cooled, it may undergo further processing, such as painting, etc. as desired. This process can be repeated for each of the hammer cutting elements 36. It will be understood that the formation of the hammer cutting element 36 in FIGS. 10-13 is substantially the same, with the exception of the area to which the coating 134 is applied.

With the hammer cutting element 36 formed, with reference to FIG. 3, the pan 34 is formed. Generally, with the body 100, the flange 102, the mounting bracket 108 and the stiffening ribs 118 formed, in one example, the pan 34 is assembled by coupling the flange 102 about the body 100. The mounting bracket 108 is coupled to the body 100, and the stiffening ribs 118 are coupled to the body 100 over the mounting bracket 108, via welding, for example. With the pan 34 assembled, the hammer cutting element 36 is coupled to the first end 110 of the mounting bracket 108 via the mechanical fastener, and the hammer cutting element 36 is coupled to the second end 112 of the mounting bracket 108 via the mechanical fastener. This process can be repeated for each of the cutting blade assemblies 32 associated with the rotary cutting implement 10.

With reference to FIG. 2, the cutting blade assembly 32 is then coupled to the rotary cutting implement 10. In one example, with the cutting chambers 22 coupled to the main frame 18 and the respective folding wing sections 20 and the hydraulic motors 30 coupled to the main frame 18 and the respective ones of the folding wing sections 20, the respective cutting blade assemblies 32 are each coupled to respective ones of the output shafts of the hydraulic motors 30. Generally, the output shafts of the hydraulic motors are received within and coupled to the bore 114a defined in the mounting bracket 108. The hydraulic motors 30 are each coupled to the hydraulic circuit. The wheel assemblies 24 can also be coupled to the main frame 18 and/or folding wing sections 20.

With the rotary cutting implement 10 assembled, the rotary cutting implement 10 can be coupled to the work vehicle 12 via the coupling mechanism 16. In operation, with reference to FIG. 1, an operator of the work vehicle 12 can input a cutting command via the human-machine interface 62, which can be received by the controller 60. The controller 60 can process the received input command, and communicate with the electrohydraulic controller 26 to output one or more control signals to drive the hydraulic motors 30, thereby rotating the cutting blade assemblies 32 to cut residue.

As the cutting blade assemblies 32 are rotated by the hydraulic motors 30, the blade 162 contacts the residue, and the sloped surface 162a of the blade 162 severs or cuts the residue. The projection 160 increases an impact force of the cutting head 132, which enables the work vehicle 12 to travel at a higher speed across the field F in comparison to cutting elements without the projection 160. For example, the work vehicle 12 can travel at a speed of about 7 kilometers per hour (kph), which is a travel speed increase of about 2 to 3 kilometers per hour (kph), which increases the productivity of the rotary cutting implement 10. The impact force of the cutting head 132 with the projection 160 is also increased by about 25% to about 35% in comparison to a cutting element without the projection 160. The projection 160 increases the weight of the hammer cutting element 36 by about 5% to about 10% in comparison to a cutting element without the projection 160; however the weight increase results in a greater inertial force, which aids in increasing the impact force. In addition, the projection 160 results in about a 20% increase in suction within the cutting chamber 22 when compared to a cutting element without the projection 160, which assists in pulling the residue up into the cutting chamber 22 to be cut by the hammer cutting element 36, thereby improving the cutting operation of the cutting blade assemblies 32 and the rotary cutting implement 10. The coating 134 applied to the cutting head 132 increases a life of the hammer cutting element 36 by about 30% as compared to an uncoated cutting element, which reduces operational costs associated with the rotary cutting implement 10.

The terminology used herein is for the purpose of describing particular embodiments only and is not intended to be limiting of the disclosure. As used herein, the singular forms “a”, “an” and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

What is claimed is:

1. A hammer cutting element for a rotary cutting implement, comprising:
a shank;
a cutting head coupled to the shank having a first surface and a second surface, the cutting head including a projection spaced apart from a blade defined on the first surface, the projection extending beyond a periphery of the shank by a first distance and the projection extending along an axis substantially oblique to a longitudinal axis defined by the hammer cutting element; and
a coating disposed on a portion of at least one of the blade, the first surface and the second surface,
wherein the hammer cutting element has a center of gravity that is offset from the longitudinal axis.

2. The cutting element of claim 1, wherein the projection is devoid of the coating.

3. The cutting element of claim 1, wherein the shank has a first body section and a second body section, the first body section extends along a first axis that is substantially parallel to the longitudinal axis, and the second body section extends along a second axis that is substantially transverse to the longitudinal axis.

4. The cutting element of claim 3, wherein the cutting head is coupled to the second body section at an angle.

5. The cutting element of claim 3, wherein the cutting head extends along a third axis, and the third axis is substantially transverse to the longitudinal axis.

6. The cutting element of claim 1, wherein the coating is disposed on a portion the second surface so as to be substantially opposite the blade.

7. The cutting element of claim 1, wherein the blade extends beyond a periphery of the shank by a second distance, and the blade has a cutting surface area that is different than a surface area of the projection.

8. The cutting element of claim 1, wherein the cutting surface area of the blade is less than the surface area of the projection.

9. A hammer cutting element for a rotary cutting implement, comprising:
a shank having a first body section offset from a second body section, the first body section extending along a first axis; and
a cutting head coupled to the second body section, the cutting head including a projection spaced apart from a blade on a first surface, the projection extending along an axis substantially oblique to the first axis and extending beyond a periphery of the shank by a first distance, the blade extending beyond a periphery of the shank by a second distance, the first distance is greater than the second distance and the blade has a cutting surface area that is different than a surface area of the projection.

10. The cutting element of claim 9, wherein the cutting head has a second surface opposite the first surface, and a coating is disposed on at least a portion of the second surface.

11. The cutting element of claim 9, wherein the first axis is substantially parallel to a longitudinal axis defined by the hammer cutting element, and the second body section extends along a second axis that is substantially transverse to the longitudinal axis.

12. The cutting element of claim 11, wherein the cutting head extends along a third axis, and the third axis is substantially transverse to the longitudinal axis.

13. The cutting element of claim 11, wherein the hammer cutting element has a center of gravity that is offset from the longitudinal axis.

14. The cutting element of claim 9, wherein the cutting head is coupled to the second body section at an angle.

15. A rotary cutting implement, comprising:
a cutting blade assembly, the cutting blade assembly including a pan and at least one hammer cutting element coupled to the pan, the hammer cutting element extending along a longitudinal axis and having a center of gravity that is offset from the longitudinal axis, the hammer cutting element including:
a shank having a first body section that extends along a first axis and a second body section that extends along a second axis, the second axis substantially transverse to the first axis;
a cutting head coupled to the second body section, the cutting head including a projection spaced apart from a blade on a first surface, the projection extending along an axis substantially oblique to the first axis and extending beyond a periphery of the shank by a first distance, the blade extending beyond a periphery of the shank by a second distance, and the first distance is greater than the second distance; and
a coating disposed on a portion of the cutting head.

16. The rotary cutting implement of claim 15, wherein the cutting head has a second surface opposite the first surface, and the coating is disposed on at least a portion of the second surface.

17. The rotary cutting implement of claim 15, wherein the cutting head is coupled to the second body section at an angle.

18. The rotary cutting implement of claim 15, wherein the cutting head extends along a third axis, and the third axis is substantially transverse to the longitudinal axis.

19. The rotary cutting implement of claim 15, wherein the projection extends for a length along the first surface, which is less than a cutting length of the blade.

20. The rotary cutting implement of claim 15, wherein the blade has a cutting surface area that is different than a surface area of the projection.
